(19) United States
(12) Patent Application Publication
(10) Pub. No.: US 2025/0201458 A1
(43) Pub. Date: Jun. 19, 2025

(54) ELECTRONIC COMPONENT, IN PARTICULAR THREE-PHASE TRANSFORMER FOR AN ISOLATED VOLTAGE CONVERTER

(71) Applicant: Valeo eAutomotive Germany GmbH, Erlangen (DE)

(72) Inventors: Amaury ROUET, Cergy Pontoise (FR); Massourang DIALLO, Cergy Pontoise (FR); Julien LEVEQUE, Cergy Pontoise (FR)

(73) Assignee: Valeo eAutomotive Germany GmbH, Erlangen (DE)

(21) Appl. No.: 18/978,762

(22) Filed: Dec. 12, 2024

(30) Foreign Application Priority Data
Dec. 14, 2023 (FR) FR2314245

(51) Int. Cl. H01F 5/02; H01F 5/04; H01F 27/28; H01F 30/12

(52) U.S. Cl. CPC H01F 5/02; H01F 27/2828; H01F 30/12; H01F 2005/022; H01F 5/04

(57) ABSTRACT

An electronic component includes a magnetic circuit, two electrical conductors each having a portion arranged around one and the same part of the magnetic circuit, each of the portions forming a winding between a first and a second end, these two windings being inductively coupled to one another via the magnetic circuit. A support of the two electrical windings is arranged between said electrical conductors and the portion of the magnetic circuit and includes a wall around which the electrical windings are arranged, and three flanges offset along the longitudinal axis of the support so that one of the electrical windings is arranged between the first and the second flange and that the other of the electrical windings is arranged between the second and the third flange, At least one step is made in the height of the first flange to locally reduce the height of the first flange.

The present invention relates to an electronic component comprising a magnetic circuit, and at least two electrical conductors each having a portion arranged around one and the same part of the magnetic circuit, each of said portions forming a winding between a first and a second end, these two windings being inductively coupled to one another via the magnetic circuit.

Such an electronic component defines, for example, a three-phase transformer for an isolated voltage converter, such a voltage converter being, for example, integrated into a component for supplying electric power to a vehicle electrical energy storage unit, also called a “charger” for this electrical energy storage unit. The electrical energy storage unit is, for example, a battery, which can have a nominal voltage greater than 60 V, for example greater than or equal to 300 V, 400 V, 800 V, or even 1000 V. The voltage converter receives, for example, an AC voltage from an electrical network and provides the battery with a DC voltage. This converter may convey a power greater than 5 kW, for example greater than 7 kW, for example greater than 11 kW, in particular of 22 kW or more.

The electronic component comprises in a known manner:
a magnetic circuit,
two electrical conductors each having a portion arranged around one and the same part of the magnetic circuit, each of said portions forming a winding between a first and a second end, these two windings being inductively coupled to one another via the magnetic circuit, and
a support of the two electrical windings, arranged between said electrical conductors and said portion of the magnetic circuit.

It is known for the elements above to be submerged in a resin able to be polymerized to harden and immobilize these elements inside a casing of the component. This resin may also be a good thermal conductor and promote the cooling of the elements contained in the casing. This resin is, for example, arranged in the casing beforehand, into which casing is introduced the assembly formed by: the magnetic circuit, the electrical conductors and the support of the two electrical windings. As a result of this introduction, the resin comes into contact with the support of the electrical windings from an axial end of the latter, and it progresses axially inside this support towards the other axial end of this support. This resin may see its progression limited by non-evacuated air, which thus stays inside the support of the electrical windings. As a result, the resin is not distributed homogenously in the casing, this potentially having the disadvantage of worse thermal dissipation and/or worse adherence of the above-mentioned elements with the casing. The above-mentioned disadvantage needs to be addressed.

The invention seeks to address this need and does so, according to one of its aspects, by means of an electronic component, comprising:
a magnetic circuit,
two electrical conductors each having a portion arranged around one and the same portion of the magnetic circuit, each of said portions of the electrical conductors forming a winding between a first and a second end, these two windings being inductively coupled to one another via the magnetic circuit, and
a support of the two electrical windings, arranged between said electrical conductors and said portion of the magnetic circuit,
   this support comprising:
a wall around which the electrical windings are arranged, and
three flanges offset along the longitudinal axis of the support so that one of the electrical windings is arranged between the first and the second flange and that the other of the electrical windings is arranged between the second and the third flange, characterized in that at least one step is made in the height of the first flange so as to locally reduce the height of the first flange.

The component may comprise a casing in which:
the electrical winding supports,
the electrical conductors, and
the magnetic circuit
   are arranged.

The casing may comprise a casing body and a cover closing this body. The casing body comprises, for example, a bottom wall and a side wall extending from the bottom wall and interposed between the bottom wall and the cover. The cover may have a plate shape.

As already mentioned, the resin progresses along the support of the electrical windings from one flange, here the third, to another flange, here the first, and this progression is performed by expelling air. The presence of the step forms a release for the air, preventing the air from remaining trapped and stopping the resin from occupying all the available space.

The step may extend radially at least from the radially inner edge of the first flange. Such an arrangement of the step is particularly favourable to form the above-mentioned release for the air.

The step for instance extends radially from the radially inner edge of the first flange up to its radially outer edge. In a variant, the step does not extend radially up to the radially outer edge of the first flange. The step extends for instance over a limited angular area, notably lying between 10° and 30° when measured from the center of the circle defined by the cross-section of the wall of the support of the electrical windings when the latter has a cylindrical shape of circular cross-section.

The step may circularly extend between two edges which may:
diverge from each other when moving away from the radially inner edge of the first flange, or
converge to each other when moving away from the radially inner edge of the first flange, or
be parallel when moving away from the radially inner edge of the first flange.

The step may be made over all the height of the first flange, thus interrupting the first flange.

As a variant, the step may be made over less of the height of the first flange, for example opening out only onto that axial surface of the first flange which is opposite the rest of the support, or opening out only onto that axial surface of the first flange which is facing towards the second flange.

A plurality of steps may come one after another circumferentially in the first flange around the perimeter of the wall of the support. The presence of a plurality of circumferentially distributed steps makes it possible to make a plurality of releases for the air as the resin progresses, further reducing the risk of the air remaining trapped.

Each of these steps may be such as described above.

Within the meaning of the present application:
“axially” means “along the axis of the wall around which the electrical windings are arranged”,
“angularly” or “circumferentially” means “while moving around this axis”, and
“radially” means “in a plane perpendicular to this axis, along a straight line cutting through this axis when this wall defines a hollow cylinder of circular cross section”.

The step may comprise, when moving radially towards the exterior of the support, two successive surfaces of different shapes, inclined with respect to one another. These two surfaces may be planes, defining an angle between them. The presence of these two planes may make it possible to keep a minimum material thickness for the first flange. As a variant, the step may have a rounded, or more generally curved, profile.

It is possible for only the first flange to have the above-mentioned one or more steps, with the second flange and the third flange preferably being devoid of said one or more steps.

The support may comprise at least two ribs extending away from the wall in the direction of the portion of the magnetic circuit.

The presence of the ribs makes it possible to extend the electrical windings further away from the portion of the magnetic circuit around which they are arranged, thus reducing the copper losses in the electronic component. Moreover, the presence of these ribs also makes it possible to create an empty space between this portion of the magnetic circuit and the support in the areas devoid of ribs, a space occupied by the above-mentioned resin, this promoting the cooling of the magnetic circuit.

The support comprises, for example, three, four, or six, or eight ribs, each extending away from the wall in the direction of the portion of the magnetic circuit. However, the invention is not limited to a particular number of ribs.

Each rib may have the same shape. As will be seen below, the wall of the support may define a hollow cylinder of circular cross section. In this case, each rib may extend radially, that is to say along a radius of this cylinder, in a plane perpendicular to its axis. When the wall of the support defines such a hollow cylinder, the above-mentioned radially inner edge and radially outer edges may be two concentric circles, in a circular cross section of this wall.

The ribs may be distributed uniformly while moving around the wall of the support. In other words, when moving around this wall, the gap between two successive ribs may remain constant.

All or some of the ribs may extend continuously along the axis of the wall of the support from the first flange to the third flange. As a variant, all or some of the ribs extend discontinuously along the axis of the wall of the support from the first flange to the third flange.

Whether the ribs extend continuously or discontinuously along the axis of the wall of the support, these ribs may be at a distance from the first flange and/or at a distance from the third flange. In other words, the ribs are not axially at the height of the first flange and/or of the third flange. This also makes it possible to free up the space for the flow of the resin as the resin progresses along the wall of the support.

All or some of the ribs may extend up to the portion of the magnetic circuit with contact with this portion. In other words, in this case, the radial space existing between the wall and the magnetic circuit is locally entirely filled by the rib. As a variant, a radial clearance may exist between the rib and the magnetic circuit.

Each electrical conductor is, for example, made of Litz wire.

In all of the above, the support may be made in one piece, being, for example, made of, for example, plastic such as polybutylene terephthalate (PBT), or polyamide (PA).

The component may comprise a guiding part of at least one of the two electrical conductors beyond each of the ends of the electrical winding that it defines, this guiding part being separate, physically speaking, from the support of electrical windings. The guiding part may comprise two walls extending along the axis of the wall of the support beyond the first flange, these two walls being offset and defining together a guiding channel for guiding at least one electrical conductor beyond the electrical winding that it defines.

The guiding part may be separate, physically speaking, from the magnetic circuit. The guiding part and the magnetic circuit are then not made as a single piece.

Where appropriate, both electrical conductors of the support may be received in the channel defined by the two walls of the guiding part. These two electrical conductors May be stacked axially in the channel or be arranged adjacent to each other. The distance between the two walls may remain constant so that the size of the channel remains constant. In all of the above, the electronic component may define a transformer for an isolated voltage converter.

In all of the above, no cooling chamber using a liquid is, for example, interposed between the electrical windings and the portion of the magnetic circuit on which the support is arranged.

The transformer is, for example, a three-phase transformer for an isolated voltage converter, comprising three supports of electrical windings, each support being arranged around a portion of the magnetic circuit and bearing two windings inductively coupled to one another via the magnetic circuit, the supports defining in particular a geometric pattern of an equilateral triangle.

Each of the electrical winding supports may then comprise one or more steps according to what has been described above.

Each support thus bears two windings which are inductively coupled to one another and which together define one phase of the three-phase transformer.

Arranging the three supports of the electrical conductors in an equilateral triangle may make it possible to guarantee that electrical parameters such as the inductances of the electrical windings are balanced and to reduce the magnetic volume.

The supports of the electrical conductors may be arranged with respect to one another so that the axes of their wall are parallel.

The magnetic circuit may be made up of two parts, each part defining a base which bears pins, superposed two by two when these two parts are assembled, and the superposition of two pads defines the part of the magnetic circuit on which a support of two electrical conductors is mounted.

Another subject of the invention, according to another of its aspects, is a component for supplying electric power to a vehicle electrical energy storage unit, comprising the transformer defined above. The electrical energy storage unit is, for example, a battery which can have one of the above nominal voltages.

The invention will be better understood on reading the description that follows of non-limiting exemplary embodiments thereof:

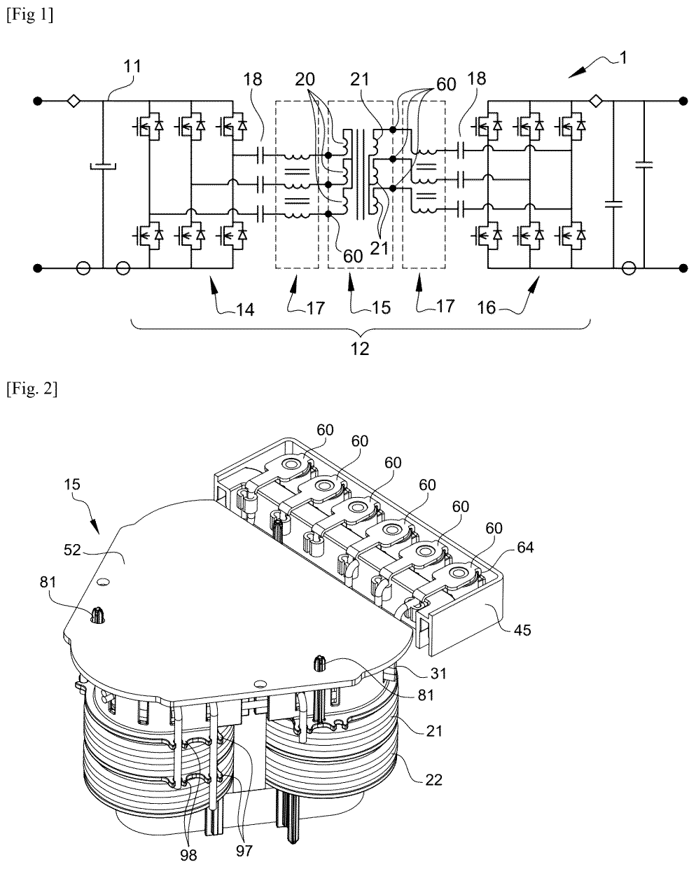

FIG. 1 schematically shows part of the electrical circuit of a component for supplying electric power to a vehicle electrical energy storage unit,

FIG. 2 shows in elevation an example of a three-phase transformer which is able to be used in the circuit of FIG. 1,

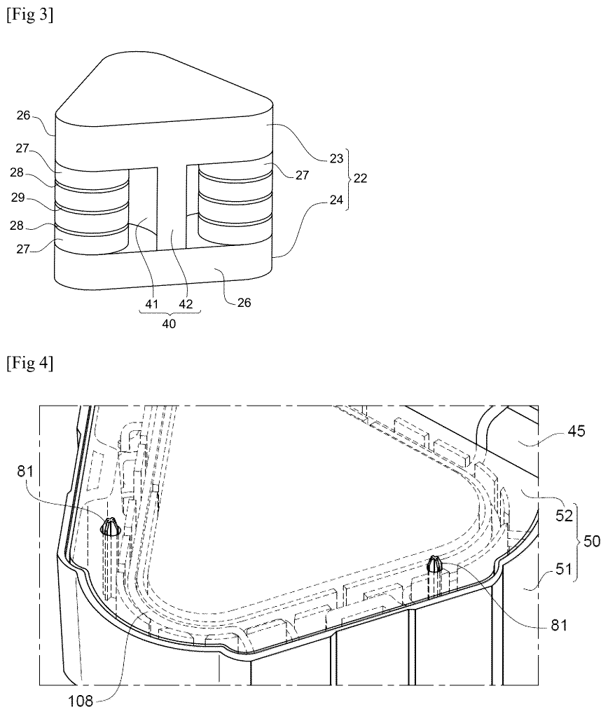

FIG. 3 shows in isolated fashion the magnetic circuit of the three-phase transformer of FIG. 2,

FIG. 4 partially shows the three-phase transformer of FIGS. 2 and 3 when the cover of the casing is removed,

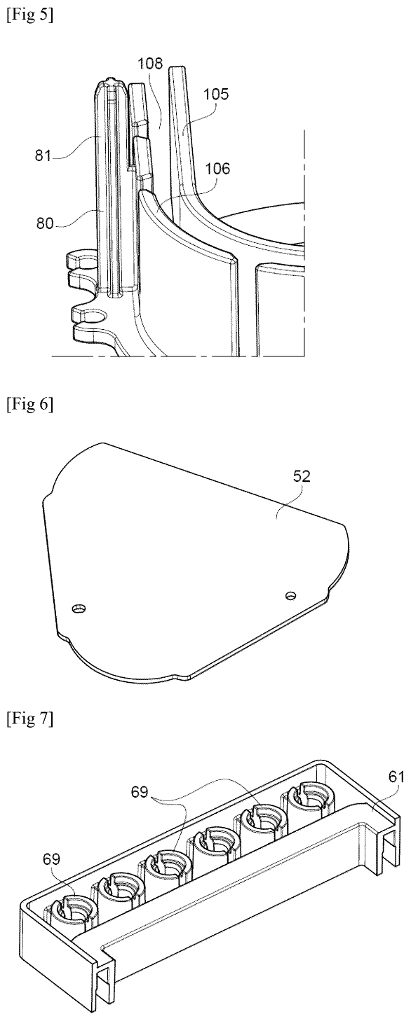

FIG. 5 shows a detail of an example of a system for holding the cover of the casing of the transformer on the support,

FIG. 6 shows the cover of the casing of FIG. 4,

FIG. 7 shows in isolation the body of the terminal block visible in FIG. 2,

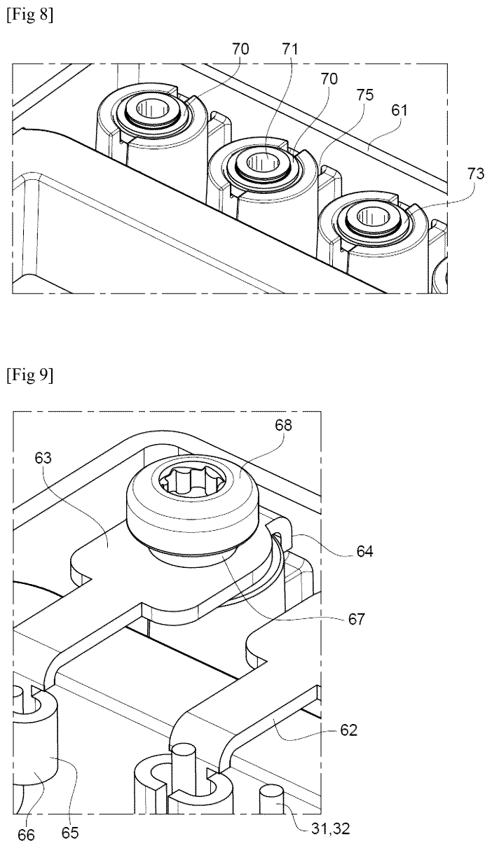

FIG. 8 shows the body of FIG. 7 in which inserts are arranged,

FIG. 9 shows the terminal block of FIGS. 7 and 8 with an electrically conductive bar and screw,

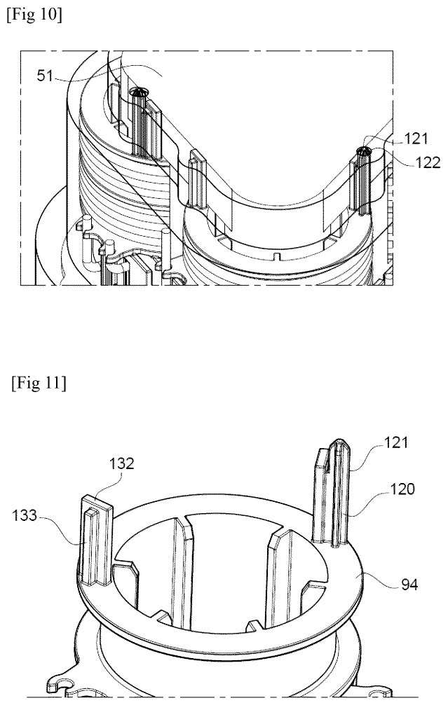

FIG. 10 shows that face of the transformer which is opposite that shown in FIG. 4,

FIG. 11 is a view of the support of the electrical conductors of the transformer from the same side as FIG. 10 and shows the system for holding the support on the magnetic circuit and the system for holding the support on the body of the casing of the transformer which are borne by this support,

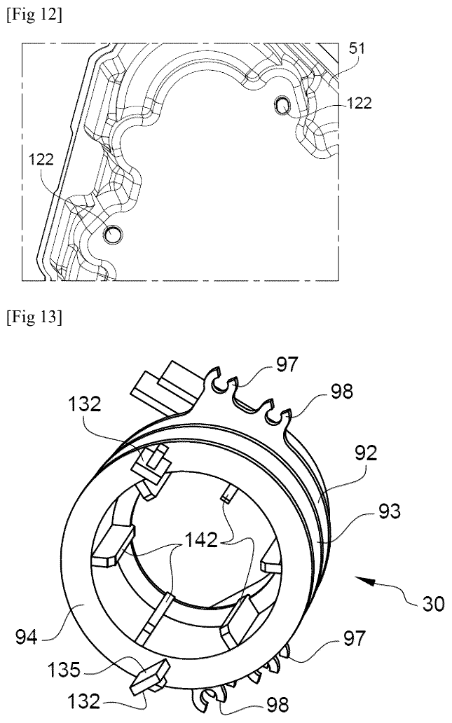

FIG. 12 shows the body of the casing of the transformer on which the support of the electrical conductors of FIG. 11 is kept,

FIG. 13 is a view similar to FIG. 11 and also shows ribs which make it possible for this support to extend away from the portion of the magnetic circuit on which it is mounted,

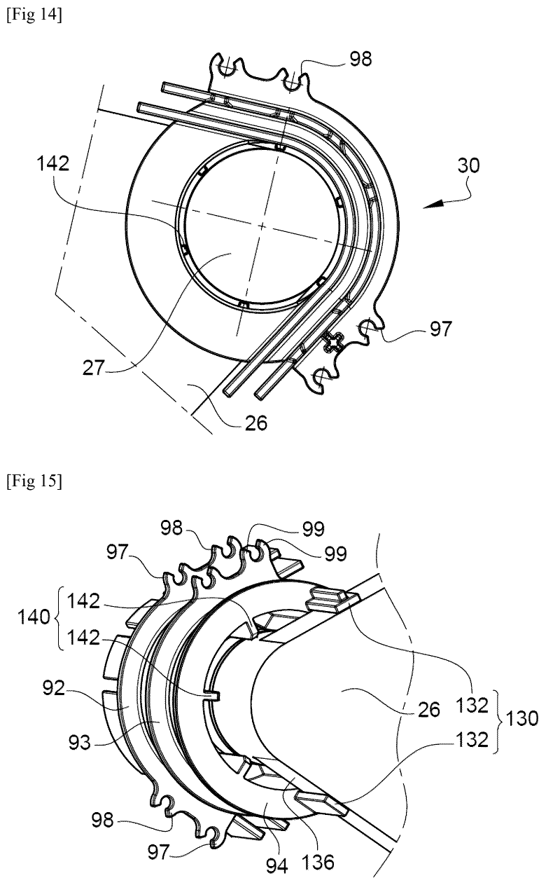

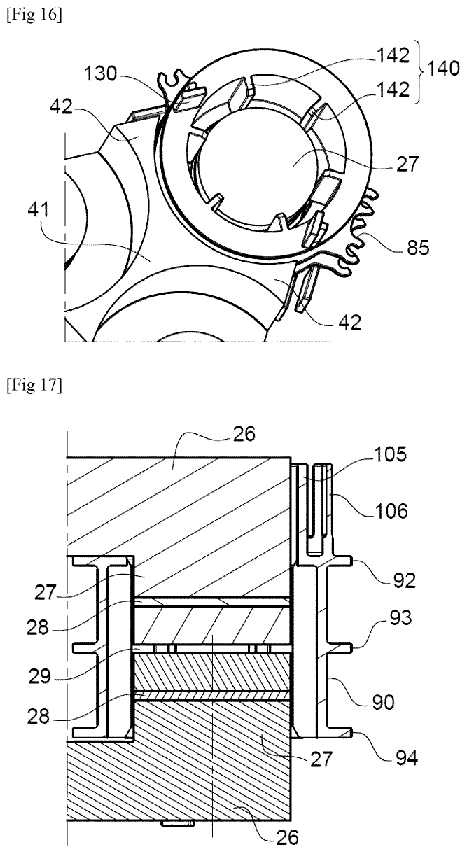

FIG. 14, FIG. 15 and FIG. 16 are views similar to that of FIG. 13 when the support of the electrical conductors is mounted on the portion of the magnetic circuit,

FIG. 17 is a cross-sectional view of FIG. 16,

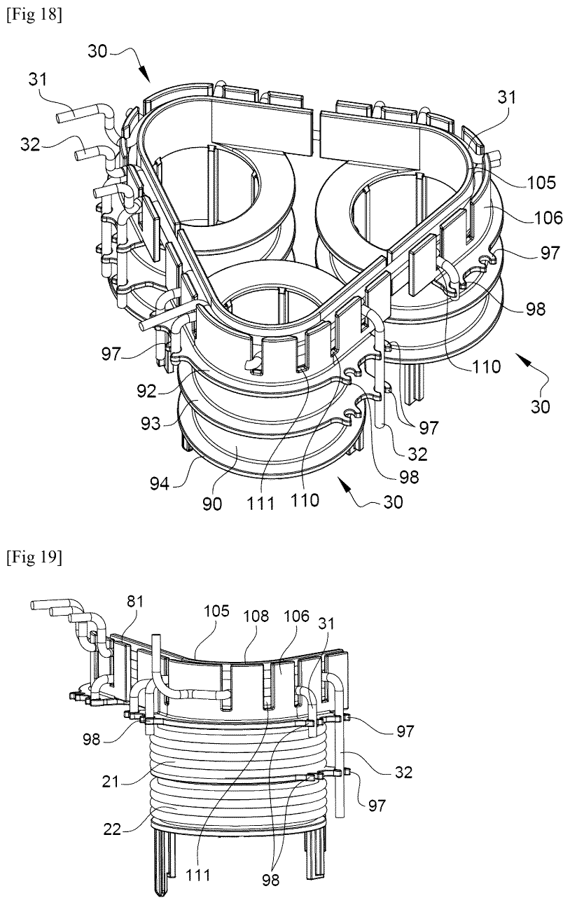

FIG. 18 shows three supports of the electrical conductors of the transformer and their electrical conductors, in the absence of the magnetic circuit,

FIG. 19 shows in isolated fashion one of the three supports of the electrical conductors of FIG. 18 with its electrical conductors,

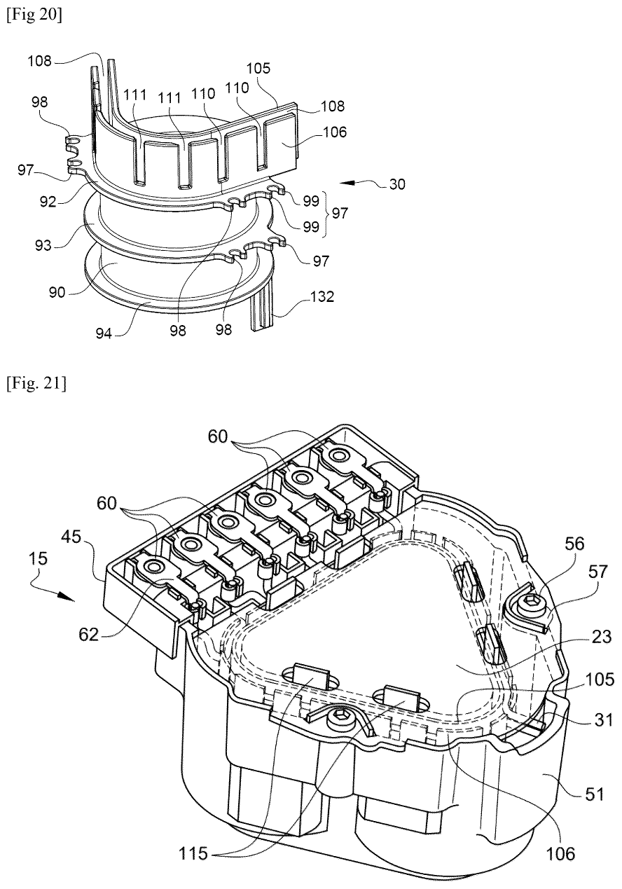

FIG. 20 shows the support of the electrical conductors of FIG. 19 without its electrical conductors,

FIG. 21 shows, in a similar way to FIG. 2, an example of a three-phase transformer which differs from that of FIGS. 2 to 20, among other things, by the way in which the cover is kept,

FIG. 22 shows, in a similar way to FIG. 2, a three-phase transformer according to an exemplary embodiment of the invention,

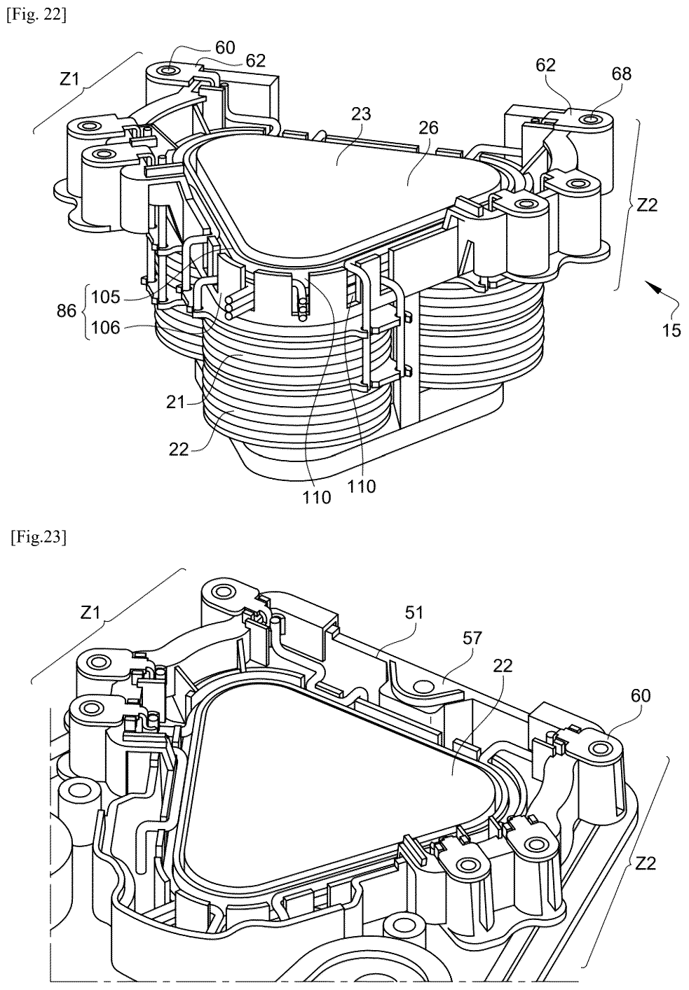

FIG. 23 shows the transformer of FIG. 22 with casing shown,

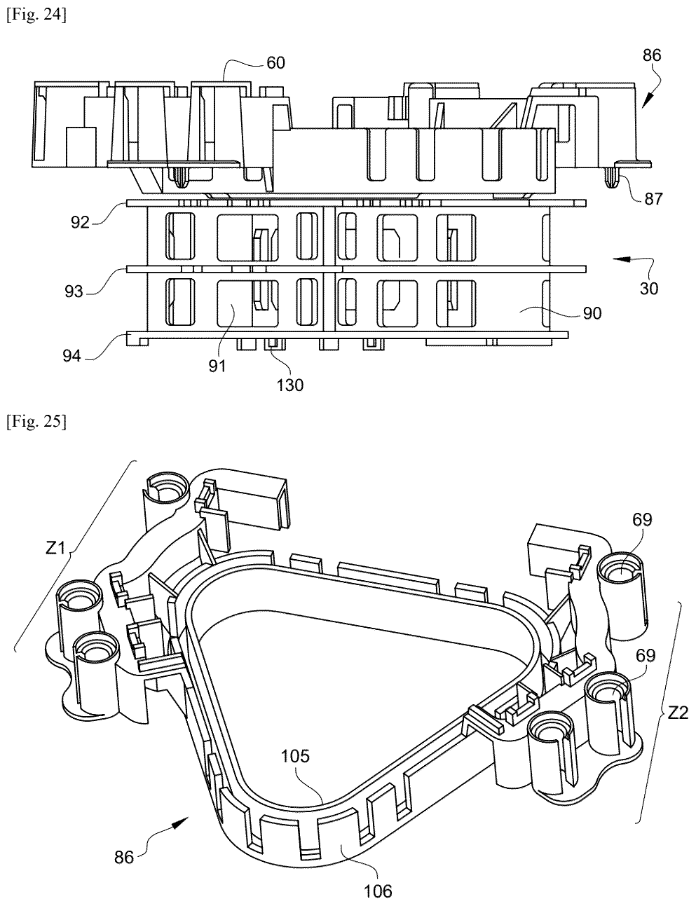

FIG. 24 shows in isolated fashion the guiding piece and the electrical winding supports of the transformer of FIGS. 22 and 23,

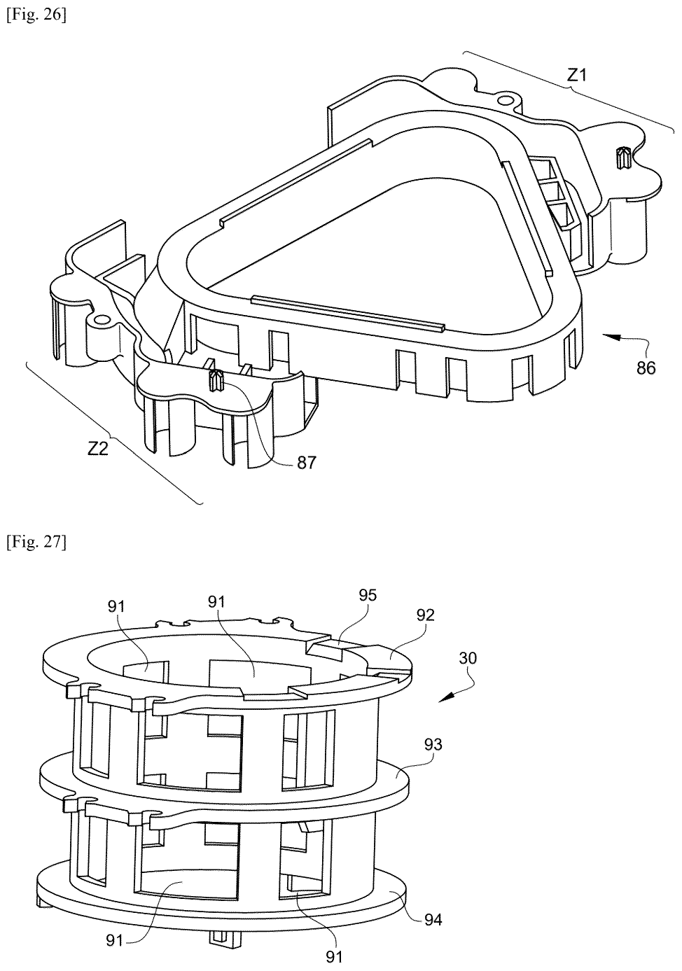

FIG. 25 shows in isolated fashion a top view of the guiding piece of FIG. 24,

FIG. 26 shows a bottom view of the guiding piece of FIG. 25,

FIG. 27 shows in isolated fashion an electrical winding support of the transformer of FIGS. 22 and 23, and

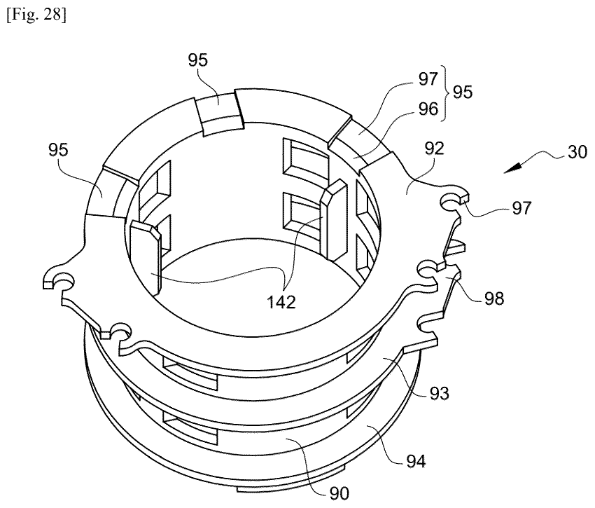

FIG. 28 is another view of the electrical winding support of FIG. 27.

FIG. 1 shows part of the electrical circuit 1 of a component for supplying electric power to a vehicle electrical energy storage unit. This component is also called a “charger”. The electrical energy storage unit, not shown in this FIG. 1, is, for example, a battery, which can have a nominal voltage greater than 60 V, for example greater than or equal to 300 V, 400 V, 800 V, or even 1000 V.

The circuit 1 receives at input an AC voltage from a network which is not shown and which is three-phase here. A rectifier which makes it possible to convert this AC voltage into a DC voltage, and also fulfilling, where applicable, a function of power factor correction, is arranged upstream of a DC bus 11. Downstream of this DC bus, from the electrical network, an insulated voltage converter 12 is arranged, being a DC/DC here. This converter 12 comprises, in a known manner, an inverter 14, a three-phase transformer 15, and a rectifier 16 providing the vehicle with a DC voltage which is isolated from the electrical network. As can be seen in FIG. 1, the three-phase transformer 15 is connected to both the rectifier 16 and the inverter 14 by a block of inductors 17 and a block of capacitors 18, so as to define a CLLLC structure. Other structures are, of course, possible, such as an LLC, CLLC, LC or else CL structure.

As can be seen in FIG. 1, each phase has a primary winding 20 and a secondary winding 21 inductively coupled to one another, and the primary windings 20 are star-connected and the secondary windings 21 are also star-connected.

The three-phase transformer 15 comprises, in the example considered, a magnetic circuit 22 comprising a first part 23 and a second part 24. Each part 23, 24 comprises: a base 26 of substantially triangular contour, and three pads 27 each extending in the direction of the base 26 of the other part of the magnetic circuit 22. Each base 26 has a contour defining an equilateral triangle here.

The transformer 15 further comprises three supports 30 of the electrical conductors 31, 32, each support 30 here being mounted on two facing pads 27 belonging to one and the other of the parts 23, 24 of the magnetic circuit, respectively. Two electrical conductors 31, 32 linked to one and the same support 30 have a portion defining a primary winding 20 and a portion defining a secondary winding 21, respectively. These electrical conductors 31, 32 are, for example, Litz wire.

As can be seen in FIG. 2, the three supports 30 of the electrical conductors 31, 32 are positioned so as to define an equilateral triangle.

The transformer 15 further comprises a casing 50 comprising a body 51 closed by a cover 52, which are visible in FIGS. 4, 6 and 21. This body 51 and this cover 52 are, for example, made of metal, for example of aluminium. The supports 30 and the magnetic circuit 22 are arranged inside the casing 50. The body 51 is filled with a resin able to be polymerized to harden and immobilize the components arranged inside the casing (“potting”).

As can be seen in FIGS. 4, 6 and 21, the casing 50 also has a triangular contour, being more precisely an equilateral triangle here. The casing is, in the example considered, exclusively formed by the body 51 and the cover 52 but the invention is not limited to a casing 50 made up of two parts.

As can be seen in FIG. 3, each pad 27 defines its own air gap 28, for example via an area of the pad 27 filled with non-magnetic material such as a composite of epoxy resin reinforced with glass fibre (FR4) or of ceramic. This area occupied by this non-magnetic material defines, for example, a whole slice of the pad. A plurality of sections are, for example, assembled with this area of the pad 27 to form this pad 27.

As can be seen in FIG. 3, an additional air gap 29 is present between the facing ends of two pads 27 belonging to different parts 23, 24 of the magnetic circuit 22, respectively. Thus, in the example of the magnetic circuit 22 considered, each magnetic field allowing inductive coupling between a primary winding 20 and a secondary winding 21 crosses exactly three air gaps.

Still in FIG. 3, it can be seen that the magnetic circuit 22 of the example considered comprises a central leg 40 borne by one of the parts 23, 24 of the magnetic circuit 22. This central leg 40 here is made in one piece with the part 23 of the magnetic circuit 22 which bears it.

It can be seen in FIG. 3 that the central leg 40 extends, in this example, continuously between two ends, each being in contact with one of the bases 26 of the magnetic circuit 22 so that no air gap is made in the central leg 40.

It can also be seen in FIG. 3 or in FIG. 16 that the central leg 40 has a core 41 and three protrusions 42 extending from this core 41, each protrusion 42 extending between two neighbouring pads 27 borne by one and the same part of the magnetic circuit.

As can be seen in FIG. 3, in the example considered, each pad 27 has a circular exterior contour, and each protrusion 42 of the central leg 40 here has a rounded wall facing the pads 27.

As can be seen in FIG. 2, the three-phase transformer 15 comprises a connection terminal block 45. The terminal block 45 here defines six terminals 60 for connecting the three-phase transformer 15 to the rest of the electrical circuit 1, these terminals 60 being shown schematically in FIG. 1. These terminals 60 here come into contact with electrical tracks of an electronic board which is not shown. In FIG. 2, and in an example which is not covered by the claims but is useful in understanding the invention, the connection terminal block 45 is attached to a side of the casing 50 of the three-phase transformer 15 and has an elongated shape. In this non-covered example, the six terminals 60 are arranged in a row.

The various elements of the terminal block 45 according to this example will now be described with reference to FIGS. 7 to 9.

The terminal block 45 here comprises a body 61 and a plurality of electrically conductive bars 62, each terminal 60 being defined by a portion 63 of a bar. Each portion 63 is planar here so as to come into contact with an electrical track of the electronic board mentioned above. The body 61 may be made of plastic, for example of PBT, PA, etc.

Each electrically conductive bar 62 has, for example, a portion 65, opposite the portion 63 defining the terminal, which is electrically connected to one of the electrical conductors 31, 32, here via a hollow sleeve 66 inside which the conductor 31, 32 is inserted, for example attached by crimping or welding.

Each electrically conductive bar 62 locally comprises a hole 67 and this electrically conductive bar 62 is attached to the body 61 by means of a screw 68 received in this hole 67. The body 61 here comprises six housings 69, and each of these housings receives an insert 70 which houses a hole 71, the above-mentioned screw 68 being received in an insert hole 71. Thus, the electrically conductive bar 62 is attached to the body 61 via the screw 68 and the insert 70 received in the housing 69. Each insert 70 may be made of metal, in particular of steel. As a variant, each insert is made of composite material. Six inserts are provided, for example, and, in the example considered, all these inserts 70 have the same shape and the same dimensions. Each screw 68 may, in addition to ensuring the attachment of an electrically conductive bar 62 to the body 61, also ensure the attachment of the electrically conductive bar 62 to the electronic board which is not shown.

As can be seen in FIG. 8, each insert 70 may define a positioning relief 73 for positioning the portion 63 of the electrically conductive bar defining the hole 67. This positioning relief 73 is, for example, a flat part of circular shape.

As can be seen in FIGS. 2, 7 and 8, the exterior wall of each housing 69 may house a recess 75 able to accommodate an end portion 64 of the electrically conductive bar 62 in order to ensure correct positioning of this bar on the body 61 and to prevent any relative rotation between this bar and this body.

In another exemplary embodiment which is not shown, the body 61 comprises a plurality of housings 69 which receive the screws 68 directly, in the absence of an insert 70. In this other exemplary embodiment, the electrically conductive bar 62 is attached to the body 61 directly via the screw 68, without an intermediate piece.

As can be seen in FIGS. 4 and 5, each support 30 of the electrical conductors may integrate a holding system 80 for holding the cover 52 on this support 30.

Each support 30 comprises, for example, a single pin 81 protruding with respect to the rest of the support 30 along the longitudinal axis of the latter. As a variant, only two of the three supports of the transformer 15 comprise a pin 81, the third support 30 being devoid of said pin.

FIG. 5 shows a pin 81 in detail, it being possible for the latter to have a section which is perpendicular to the longitudinal axis of the support and which is cruciform. Each pin 81 of a support 30 of the electrical conductors is, in the example considered, received by force in an opening made in the cover 52, as can be seen in FIG. 4. The relative arrangement of the pins 81 of the supports 30 makes it possible to immobilize the cover 52.

As can be seen in FIG. 5, the holding system 80 for holding the cover 52 on the support 30 may extend along the longitudinal axis of the support 30 on the same side of the support 30 as a guiding system 85 for guiding electrical conductors, which will be described with reference to FIGS. 18 to 20.

In these FIGS. 18 to 20, the holding system 80 is not shown, it being possible for the guiding system 85 to be present without necessarily the holding system 80 being present.

As can be seen in FIG. 18, each electrical conductor 31, 32 borne by a support 30 of the transformer 15 may be guided outside the winding 20, 21 that it defines.

In the example considered, each of these conductors 31, 32 is guided by the guiding system 85 beyond each of the ends of the electrical winding 20, 21 that it defines. As already mentioned above, the first ends of the electrical conductors may form an output towards the electrical circuit 10 outside the transformer 15, and three of the second ends of the electrical conductors may lead towards a common point via a star connection to the primary, and three others of these second ends of the electrical conductors may lead towards a common point via another star connection to the secondary.

The support 30 of the two electrical windings 31, 32 comprises:
a wall 90 around which the electrical windings 20, 21 are arranged, and this wall 90 defines, in the example considered but in a non-limiting manner, a hollow cylinder of circular cross section, and
three flanges 92, 93, 94 offset along the longitudinal axis of the support so that one of the electrical windings 31 is arranged between the first 92 and the second 93 flange and that the other of the electrical windings 32 is arranged between the second 93 and the third 94 flange, as is clearly visible in FIG. 2 for example. The gap between two consecutive flanges 92, 93 and 93, 94 remains constant in the example considered.

Although this is not visible in FIGS. 11 to 20, the wall 90 may comprise one or more apertures 91 which will be described in detail with reference to FIGS. 27 and 28.

The guiding system 85 acts on the electrical conductors, on the one hand via clips 97 and 98, and on the other hand via additional walls 105 and 106.

In the example of FIGS. 18 to 20, the guiding system 85 comprises, for each electrical conductor 31, 32, on the one hand a first clip 97 cooperating with this electrical conductor 31, 32 beyond the first end of the electrical winding 20, 21 that it defines. Such a clip 97 has, for example, two curved arms 99 so as to fit closely with an area of the contour of this end of the electrical conductor, as shown in FIG. 18 or 20. A circular contour is involved in this case. Each clip 97 is, for example but in a non-limiting manner, made in one piece with the rest of the support 30 of the electrical conductors. As already explained, each first clip 97 cooperates, for example, with a portion of the electrical conductor 31, 32 on the way towards a connection terminal 60.

The guiding system 85 comprises, on the other hand, a second clip 98 cooperating with the electrical conductor beyond the second end of the electrical winding that it defines, these first 97 and second 98 clips coming one after another along one of the first 92, second 93 and third 94 flanges. As already explained, each second clip 98 cooperates, for example, with a portion of the electrical conductor 31, 32 on the way towards a common point of a star connection.

More precisely, in the example considered:
the first flange 92 comprises two first clips 97 which each respectively cooperate with one of the electrical conductors 31, 32 beyond the first end of the electrical winding 20, 21 that it defines, and two second clips 98 which each respectively cooperate with an electrical conductor beyond the second end of this electrical winding 20, 21, and
the second flange 93 comprises a first clip 97, arranged beneath a first clip 97 of the first flange 92, and a second clip 98, arranged beneath a second clip 98 of the first flange. The clips borne by the second flange 94 make it possible to guide the electrical conductor 32 outside the electrical winding arranged between the second flange 93 and the third flange 94.

It can be seen in FIGS. 18 to 20 that two pairs of clips each formed of a first clip 97 and of a second clip 98 are found along the flange 92 and that the gap between two pairs of clips is greater than the distance between two clips of the same pair.

It can also be seen in these FIGS. 19 and 20 that the clips 97, 98 borne by the second flange 93 are aligned along the axis of the cylindrical wall 90 with clips 97, 98 borne by the first flange 92.

The two additional walls 105 and 106 of the guiding system 85, which in the example of FIGS. 2 to 20 are integrated in the support 30, will now be described. This integration of the walls 105 and 106 in one piece with the support 30 is not covered by the claims but is useful in understanding the invention. These two additional walls 105 and 106 here are offset so as to define between them a guiding channel 108 receiving in a stacked manner the electrical conductors 31, 32 outside the windings 20, 21 that they define. The channel 108 has a constant dimension here. These additional walls extend, in the example considered, on both sides of an arc-shaped portion of the first flange 92, protruding axially beyond this first flange 92. In the area overlapping with this first flange 92, the additional walls 105 and 106 each define an arc-shaped portion, the wall 106 having a radius of greater than the wall 105, as is also visible in FIG. 17.

It can be seen in FIGS. 18 to 20 that the wall 106 comprises first openings 110 for the passage of the electrical conductors 31, 32 towards the electrical winding 20, 21 that it defines, and second openings 111 through which no electrical winding passes. It can be seen that the first openings 110 are arranged radially facing a clip 97, 98.

In the example of FIGS. 10 to 12, each support 30 of the electrical conductors 31, 32 also integrates a holding system 120 for holding onto the body 51 of the casing 50. This holding system 120 here comprises a pin 121 having, in this example, a section which is perpendicular to the longitudinal axis of the support and which is cruciform. This pin 121 extends axially away from the rest of the support 30 from the third flange 94. As can be seen in FIGS. 10 and 12, each pin 121 is received by force in an opening 122 made in the body 51 of the casing 50. This holding system may ensure that the magnetic circuit 22 is immobilized on the body 51 of the casing before the resin contained in this casing 50 polymerizes.

When such holding systems 120 exist, they may or may not be combined with the holding systems 80 and the guiding systems 85 mentioned above. As can be seen in FIGS. 10 to 12, each holding system 120 may thus extend axially from one side of the support 30 while the holding system 80 and the guiding system 85 extend axially from the opposite side of the support 30.

A functionality which may be integrated into all or some of the supports 30 of the electrical conductors 31, 32 will now be described with reference to FIGS. 13 to 15. A holding system 130 for holding the support 30 of the electrical conductors 31, 32 on the magnetic circuit 22 is thus provided. This holding system 130 is in the form of two blocks 132 protruding with respect to the rest of the support 30. When the holding system 120 is provided, these systems 130 and 120 may extend axially from the same side of the support, the pin 121 and a block 132 being in particular arranged side-by-side as can be seen in the example of FIG. 11.

Each block 132 here defines a surface 135 coming into contact with a surface 136 of a base 26 of the magnetic circuit 22. The surfaces 135 and 136 are planar here. Each block 132 is, for example, supported by a reinforcement 133, as can be seen in FIG. 11.

As can be deduced from FIG. 15, the cooperation between the two blocks 132 of a support 30 and the base 26 may ensure that the support 30 is immobilized with respect to rotation on the magnetic circuit 22.

Another functionality which may be integrated into all or some of the supports 30 of the electrical conductors 31, 32 will now be described with reference to FIGS. 13 to 16. It can be seen in these figures that the cylindrical wall 90 of the support 30 comprises ribs 142 extending away from the wall 90 in the direction of the pad 27 on which this support is mounted.

In the example considered, six ribs 142 are provided but the invention is not limited to a precise number of ribs 142. These six ribs 142 thus make up a spacing system 140 for spacing the cylindrical wall 90, and therefore the electrical windings 20, 21 that it bears, from the pad 27.

It can be seen in FIGS. 13 to 16 that all the ribs 142 may have the same shape and be distributed uniformly around the pad 27.

It can also be seen in these figures that each rib 142 may extend continuously along the axis of the support 30 from the first flange 92 up to the third flange 94.

In a variant which is not shown, all or some of the ribs extend discontinuously along the axis of the support 30.

As can be seen in FIG. 16, each rib 142 does not extend, for example, up to the pad 27 on which the support 30 is mounted. An empty space ensuring easy mounting thus remains present between each end of a rib facing the pad 27 and this pad 27.

As already mentioned, each support 30 of the electrical conductors 31, 32 may be made in one piece.

When this support 30 integrates:
the ribs 142, and/or
the holding system 80 for holding the cover 52 on the support, and/or
the guiding system 85 for guiding electrical conductors, and/or
the holding system 120 for holding the support on the body 51 of the casing, and/or
the holding system 130 for holding the support on the magnetic circuit 22,
   all these systems may or may not be made in one piece with the rest of the support 30. In one particular example, the support 30 is thus in one piece and has all or some of the above-mentioned functionalities.

In the example of FIG. 21, the cover 52 is held directly on the body 51 of the casing 50 via screws 56 received in a flange 57 of the wall of the body 51. The cover 52, which is shown transparently in this FIG. 21, may seal the body 51, thus ensuring EMC shielding of the casing 50.

It can be seen in this FIG. 21 that the wall 105 of the guiding system 85 may have additional protrusions 115 received in openings made in the cover 52. These additional protrusions 115 define, for example, two slots per side of the transformer 15, and they may facilitate the introduction of the magnetic circuit 22, equipped with supports 30, into the body 51 of the casing 50.

A transformer 15 according to one exemplary embodiment of the invention will now be described with reference to FIGS. 22 to 28.

As can be seen, this transformer 15 differs from that which has been described previously with reference to FIGS. 2 to 21 in that the terminal block 45 is no longer arranged on a single side of the casing 50 but extends over the entire perimeter of the magnetic circuit 22. The terminal block 45 also differs from that which has been described previously in that the body of the terminal block 86 bears the walls 105, 106 defining the guiding channel 108 for guiding the electrical conductors beyond the electrical winding 20, 21 that they define. Thus, the terminal block 45 here defines, via its body 86, a guiding piece which is separate, physically speaking, from the support 30 of the electrical windings, this being in particular visible in FIG. 24.

Similarly to what has been described with reference to FIGS. 18 to 20, the wall 106 of the body of the terminal block 86 comprises first openings 110 for the passage of the electrical conductors 31, 32 towards the electrical winding 20, 21 that it defines. The wall 105 is devoid of openings here. In the exemplary embodiment described, the wall 106 does not comprise openings 111 through which any electrical winding passes but it could comprise them in a variant.

Similarly to what has been described with reference to FIGS. 18 to 20, first openings 110 are arranged radially facing a clip 97, 98. Clips 97, 98 are also provided here on the first flange 92 and the second flange 93.

The body of the terminal block 86 is shown in isolated fashion in FIGS. 25 and 26. It can be seen that it extends over the entire perimeter of the magnetic circuit 22 here. As shown in these FIGS. 25 and 26, the body of the terminal block 86 has a first surface which bears connection terminals 60 for connecting the transformer 15 to the rest of the electrical circuit of the converter 15. Each terminal 60 is directly borne by the body of the terminal block 86 here. The terminal block 45 further comprises electrically conductive bars 62 a portion 63 of which defines a terminal 60, similarly to what has been described with reference to FIGS. 7 to 9.

As described with reference to FIGS. 7 to 9, each electrically conductive bar 62 may be attached to the body of the terminal block 86 by means of a screw 68 received in a hole 67 of the bar 62, either by direct cooperation between this screw 68 and a housing 69 of the guiding piece 86, or via an interposed insert 70.

As can be seen in FIGS. 22 to 26, the terminal block according to this exemplary embodiment is different from that described with reference to FIGS. 2 to 21.

Specifically, in the example of FIGS. 22 to 28, the six terminals 60 are distributed between two zones Z1 and Z2 which are separate and at a distance from one another on the perimeter of the magnetic circuit 22. It can be seen in FIG. 22 that each zone Z1, Z2 defines exactly three terminals for connecting the three-phase transformer 15 to the rest of the isolated voltage converter 12. One of the zones Z1 corresponds, for example, to the terminals for connecting the primary side of the transformer 15 while the other zone Z2 corresponds to the terminals for connecting the secondary side of the transformer.

It can also be seen in FIG. 22 that each zone Z1, Z2 may be arranged facing a respective vertex of one of the bases 26 of the magnetic circuit 22. In the example considered, the vertices in question are rounded and each zone Z1, Z2 fits closely with the exterior shape of one of these rounded parts.

Still in FIG. 22, it can be seen that, within a zone Z1, Z2, the gap between two consecutive terminals 60 is not constant.

Each zone Z1, Z2 defining terminals here forms a protrusion radially exterior with respect to the walls 105, 106. More precisely in the example considered, each zone Z1, Z2 defines an ear with respect to the space delimited externally by the two walls 105 and 106.

As shown in FIG. 26, the second surface of the body of the terminal block 86, opposite that surface which bears the connection terminals 60, bears, in the example described, attachment reliefs 87 for attaching to the body 51 of the casing 50. Two attachment reliefs 87, each being a pin, may be provided. Each attachment relief 87 is, for example, made in the second surface of the body of the terminal block 86, in the region of a zone Z1, Z2.

The support 30 of the electrical windings according to this exemplary embodiment of the invention will now be described in more detail. This support 30 always has a wall 90 around which the electrical windings 20, 21 are arranged and which defines a hollow cylinder of circular cross section here, and three flanges 92, 93, 94 offset along the longitudinal axis of the support. The presence of the clips 97 and 98 on the first flange 92 and the second flange 93 can still be seen.

As shown in FIG. 27, the support 30 here has a wall 90 comprising a plurality of apertures 91. The apertures 91 here are made through the entire thickness of the wall 90.

The apertures 91 are distributed between:
a first series of apertures coming one after another on the perimeter of the support 30 between the first flange 92 and the second flange 93, and
a second series of apertures coming one after another on the perimeter of the support 30 between the second flange 93 and the third flange 94.

Each series of apertures comprises, for example, three or four apertures 91.

Each aperture 91 has a substantially rectangular closed contour here. Each aperture 91 extends, in the example considered, over an angular sector which is measured from the axis of the wall 90 of the support 30 and which is comprised between 10° and 70°.

It can be seen in FIGS. 27 and 28 that two consecutive apertures 91 of the same series may have different dimensions, their circumferential dimension varying, for example, while their axial dimension remains constant.

It can also be seen in FIGS. 27 and 28 that two apertures 91 belonging to two different series and coming one after another axially may have the same dimensions.

According to the invention, and as can be seen in FIGS. 27 and 28, steps 95 are made in the height of the first flange 92. More precisely, in the example of FIG. 28, steps 95 are made on that exterior surface of the first flange 92 which is furthest away from the rest of the support 30, resulting in a local reduction in the height of the first flange 92. These steps 95 come one after another circumferentially over the perimeter of the first flange 92 here. It can be seen in FIG. 28 that these steps 95 are concentrated in a given angular sector of the first flange 92. This angular sector measures, for example, less than 120°, even less than 90°, when measured from the axis of the support 30. One can see also that each step 95 extends in the embodiment shown from the radially inner edge of the first flange 92 up to its radially outer edge. Each step 95 extends here circularly between two edges which are parallel.

Each step 95 is, for example, identical. Each step 95 has, for example, when moving radially towards the exterior of the support 30, two successive surfaces 96, 97 of different shapes, which are inclined with respect to one another and which are planar surfaces here. In a variant which is not shown, each step 95 could have a rounded, or more generally curved, profile.

It can also be seen in FIG. 28 that the ribs 142 are still present, although having a reduced height and not extending up to the first flange 92 and not extending up to the third flange 94. The steps 95 thus open out radially towards the interior towards a part of the wall 90 which is devoid of ribs 142.

Each support 30 of the electrical windings of FIGS. 27 and 28 may comprise all or some of the following:
the holding system 80 for holding the cover 52 on the support of FIGS. 4 and 5, and/or
the holding system 120 for holding the support on the body 51 of the casing of FIGS. 10 to 12, and/or
the holding system 130 for holding the support on the magnetic circuit 22 of FIGS. 10 to 15.

The invention is not limited to the example which has just been described.

1. Electronic component, comprising:
a magnetic circuit,
two electrical conductors each having a portion arranged around one and the same portion of the magnetic circuit, each of said portions of the electrical conductors forming a winding between a first and a second end, these two windings being inductively coupled to one another via the magnetic circuit, and
a support of the two electrical windings, arranged between said electrical conductors and said portion of the magnetic circuit,
this support comprising:
a wall around which the electrical windings are arranged, and
three flanges offset along the longitudinal axis of the support so that one of the electrical windings is arranged between the first and the second flange and that the other of the electrical windings is arranged between the second and the third flange,
wherein at least one step is made in the height of the first flange so as to locally reduce the height of the first flange, this step extending radially at least from the radially inner edge of the first flange.

2. Component according to claim 1, wherein the step is made over less of the height of the first flange, opening out into that exterior surface of the first flange which is the furthest away from the rest of the support.

3. Component according to claim 1, comprising a plurality of steps made in the height of the first flange, these steps coming one after another circumferentially around the perimeter of the wall.

4. Component according to claim 1, the step comprising, when moving radially towards the exterior of the support, two successive surfaces of different shapes, inclined with respect to one another.

5. Component according to claim 3, the two surfaces being planes, defining an angle between them.

6. Component according to claim 1, the support comprising at least two ribs extending away from the wall in the direction of the portion of the magnetic circuit.

7. Component according to claim 6, all or some of the ribs extending continuously along the axis of the support in an area of the support at a distance from the first flange.

8. Component according to claim 1, the wall around which the electrical windings are arranged being cylindrical with a circular cross section.

9. Component according to claim 1, the support being made in one piece.

10. Component according to claim 1, comprising a guiding part of at least one of the two electrical conductors beyond each of the ends of the electrical winding that it defines, this guiding part being separate from the support of the two electrical windings.

11. Component according to claim 1, defining a transformer for an isolated voltage converter.

12. Component according to claim 11, defining a three-phase transformer for an isolated voltage converter, comprising three supports of the electrical conductors, each support being arranged around a portion of the magnetic circuit and bearing two windings inductively coupled to one another via the magnetic circuit, the supports defining in particular a geometric pattern of an equilateral triangle.

13. Component for supplying electric power to a vehicle electrical energy storage unit, comprising the component according to claim 11.

14. Component according to claim 2, comprising a plurality of steps made in the height of the first flange, these steps coming one after another circumferentially around the perimeter of the wall.

15. Component according to claim 2, the step comprising, when moving radially towards the exterior of the support, two successive surfaces of different shapes, inclined with respect to one another.

16. Component according to claim 2, the support comprising at least two ribs extending away from the wall in the direction of the portion of the magnetic circuit.

17. Component according to claim 2, the wall around which the electrical windings are arranged being cylindrical with a circular cross section.

18. Component according to claim 2, the support being made in one piece.

19. Component according to claim 2, comprising a guiding part of at least one of the two electrical conductors beyond each of the ends of the electrical winding that it defines, this guiding part being separate from the support of the two electrical windings.

20. Component according to claim 2, defining a transformer for an isolated voltage converter.
